(19) United States
(12) Patent Application Publication
(10) Pub. No.: US 2008/0069625 A1
(43) Pub. Date: Mar. 20, 2008

(54) KEYBOARD GUARD APPARATUS AND SYSTEM

(76) Inventor: Jewel L. Dohan, Newport Beach, CA (US)

Correspondence Address: Rutan & Tucker, LLP., 611 ANTON BLVD, SUITE 1400, COSTA MESA, CA, 92626, US

(21) Appl. No.: 11/850,803

(22) Filed: Sep. 6, 2007

Related U.S. Application Data
(63) Continuation-in-part of application No. 11/843,226, filed on Aug. 22, 2007.
(60) Provisional application No. 60/839,507, filed on Aug. 22, 2006.

(51) Int. Cl. B41J 29/12

(52) U.S. Cl. 400/715

(57) ABSTRACT

An apparatus and a system is provided that prevents the inadvertent striking of a computer keyboard key by a user's finger. The present invention may be utilized in either Original Equipment fashion or may be retrofitted to an existing computer keyboard to provide the user with an efficient deterrent system to accidental striking of a computer key. The apparatus is a removably attachable device comprising a solid one piece shaped device configured in either a ‘T’ configuration and/or an “L” configuration whereby the device has a vertical member attached to a horizontal member wherein the vertical member is configured to fit between the keys and facilitating a deterrent to the typist in inadvertently striking a blocked key.

### PRIORITY CLAIM

This application claims priority to the earlier filed provisional application having a Ser. No. 60/839,507 filed on Aug. 22, 2006.

### FIELD OF THE INVENTION

The present invention relates generally to the field of computer hardware. More specifically, the present invention relates to an apparatus and system for guarding a user against the inadvertent striking of certain keys of a standard computer keyboard.

### BACKGROUND OF THE INVENTION

A computer keyboard has become a very common piece of computer hardware in today's technologically advanced society. The keyboard can be found not only on computer hardware but on handheld devices, cell phones and a host of other products. The prior art, traditional computer keyboard owes its look and feel to the older typewriter keyboard from which it evolved. The typical typewriter keyboard utilized the QWERTY layout for the letter keys that are now used in virtually all computer and accessory keyboards.

The QWERTY layout was originally designed to minimize the jamming of the keys together as the keyboard design on those typewriters utilized a key attached to a mechanical arm that when pressed, caused the printing of a block letter onto the paper desired.

Computer keyboard keys are arranged to be rectangular or square type keys that have numbers, characters and/or letters labels thereon to allow the user to determine which keys they are striking. Typically, only one key is used at a time; however, there are instances where multiple keys must be utilized to garner the right results. This includes capitalization of a letter and/or utilizing specific symbols contained on one or more keys. The use of these different keys usually arises because of the user's need to access different symbols such as the money sign, percentage signs, and certain types of punctuation marks including question marks and the like.

However, when typing on a conventional “QWERTY” designed computer keyboard, there is a tendency to inadvertently hit one key that causes an undesired change in sentence formation. This key happens to be the Caps Lock key. Although certain programs including Microsoft Word allow for the reversal of unwanted cap case changes, the typist must still stop typing in order to correct the mistaken cap case error.

The Caps Lock key is located next to the vowel ‘a’ as well as the letter ‘q’ key. When hitting the letter ‘a’ or the letter ‘q’, a typist's finger often mistakenly overshoots these keys and ends up striking the Caps Lock key. Additionally, oftentimes, the typist will mistakenly strike both the intended letter key and the Caps Lock key causing the unwanted change of case. This can be problematic essentially when typing at a faster rate because a significant amount of information may be typed after the unwanted change of case has occurred, forcing the typist to stop the information transfer and to correct the problem that may have occurred because of the mistake in key selection.

One way to avoid mistakenly striking the Caps Lock key is to place the Caps Lock key in another location on the keyboard. However, because of the common configuration of the keyboard, this would be costly and could cause potential problems trying to learn and adapt to the new location of the Caps Lock key.

Another solution to the mistaken striking of the Caps Lock key is to create a new, different Caps Lock key for the keyboard wherein the new key would replace the existing Caps Lock key. The new replacement key would have a new design such as a larger key with a higher elevation which would make inadvertent striking of the key much more difficult because it would require lifting of the finger to a higher elevation in order to depress the key. The problem in this example is the replacement of the key with another Caps Lock key. The user would be required to take a keyboard apart and insert a new key. The potential for ruining and the disastrous effects of taking apart the keyboard are obvious in this situation.

Therefore, a need still exists for an apparatus and a system for preventing inadvertent striking of the Caps Lock key or any other key on the keyboard that a user desires to avoid accidental striking thereof. Additionally, a need also exists for an apparatus and a system that can be built into an Original Equipment keyboard from the factory while incorporating the desired Caps Lock device directly. Still further, a need also exists for an apparatus and a system for preventing inadvertent striking of the Caps Lock key or any other key on a keyboard wherein the device may be retrofitted to any existing computer keyboard apparatus to allow a user to avoid inadvertent striking of an undesired key when the device is in place.

### SUMMARY OF THE INVENTION

The present invention relates to an apparatus and a system that may prevent inadvertent striking of a computer keyboard key. The present invention may be utilized in either Original Equipment fashion or may be retrofitted to an existing computer keyboard to provide the user with an efficient deterrent system to accidental striking of a computer key. The apparatus is a removably attachable device comprising a solid one piece shaped in a ‘T’ configuration with the vertical member attached to a horizontal member wherein the vertical member is configured to fit between the keys and thereby not allow for easy accessibility to the blocked key by the typist. However, it should be understood that the apparatus and system does not completely inhibit a user for using the blocked key when actually desired by the user.

To this end, in an exemplary embodiment of the present invention, an apparatus for precluding the inadvertent striking of a keyboard key is provided. The apparatus has a removably attachable key, the key guard having at least a vertical member and a horizontal member. Additionally, the apparatus has a key guard affixed to at least one key and further wherein the at least vertical member and the horizontal member preclude inadvertent striking of a specific key on a keyboard.

In an exemplary embodiment, the key guard has an adhesive thereon to attach the key guard to at least a portion of a keyboard.

In an exemplary embodiment, the key guard has an adhesive on the vertical member and the horizontal member whereby both the vertical and the horizontal member may be fixably attached to the keyboard.

In an exemplary embodiment, the key guard has a vertical member whereby the vertical member is sized to extend from a base position on a standard keyboard to a position above the top edge of any key on a keyboard.

In an exemplary embodiment, the key guard is intended to be used to preclude inadvertent striking of the Caps Lock key.

In an exemplary embodiment, the key guard is intended to be utilized to preclude the inadvertent striking of any individual key on a keyboard.

In an exemplary embodiment, the key guard is intended to be utilized to preclude the inadvertent striking of any combinations of keys on a keyboard.

In an exemplary embodiment, the key guard is removable from a single key on a keyboard and may be further utilized to preclude striking of another key on a keyboard.

In an exemplary embodiment, the key guard is permanently built into an original equipment by a manufacturer.

In an exemplary embodiment, the key guard may be retrofitted to any existing keyboard by a user.

In an exemplary embodiment, the key guard is constructed of metal.

In an exemplary embodiment, the key guard is constructed of plastic.

In an exemplary embodiment, the key guard is constructed of any suitable rigid material that precludes a user from the inadvertent striking of a keyboard key.

To this end, in an exemplary embodiment of the present invention, a method for utilizing a keyboard key guard, the method comprising the steps of: providing an attachable key guard to a keyboard, the key guard having at least a vertical member and a horizontal member; and providing a key guard that is affixed to at least one key.

In an exemplary embodiment, the method further comprises the step of: allowing for utilization of the key guard with existing keyboard applications.

In an exemplary embodiment, the method further comprises the step of: allowing for utilization of the key guard with original keyboard equipment.

In an exemplary embodiment, the method further comprises the step of: providing an adhesive to allow for attachment of the key guard to any specific key on a keyboard.

In an exemplary embodiment, the method further comprises the step of: providing an adhesive to allow for attachment of the key guard to any combination of keys on a keyboard.

In an exemplary embodiment, the method further comprises the step of: placing the vertical member between any two keys on a keyboard and allowing the horizontal member to cover at least a portion of any specific key whereby when the horizontal member is struck by a user, it will not cause depression of the key because the key guard will be forced in a downward position whereby the vertical member attached to the horizontal member would hit the base portion of the keyboard and thereby preclude further downward motion of the key guard relative to the top edge of the keyboard.

To this end, in an exemplary embodiment of the present invention, an apparatus and system for guarding against inadvertent striking of a key is provided.

In another exemplary embodiment, an apparatus and a system for guarding against inadvertent striking of a key is provided whereby the device may be applied to an OEM computer keyboard.

Another exemplary embodiment of the present invention is an apparatus and system that guards against accidental key striking whereby the device is removable.

Yet another exemplary embodiment of the present invention is to provide an apparatus and a system that guards against accidental key striking whereby the device is inexpensive to make and easy to use by either the OEM market or the individual user.

Still another exemplary embodiment of the present invention is to provide an apparatus and a system that guards against accidental striking of a computer key whereby the device may fit almost all computer keyboards.

An exemplary embodiment of the present invention is to provide an apparatus and a system that guards against accidental striking of a computer key whereby the device may be constructed of plastic.

Yet another exemplary embodiment of the present invention is to provide an apparatus and a system that guards against accidental striking of a computer key whereby the device may be constructed of metal.

Another exemplary embodiment of the present invention is to provide an apparatus and a system that guards against accidental striking of a computer key whereby the device may be constructed of any suitable rigid material.

In an exemplary embodiment of the present invention, an apparatus and a system that may guard against accidental striking of a computer key is provided whereby the device may be constructed of a malleable, foam-like material that may be compressed when a laptop is in the closed position.

Still another exemplary embodiment of the present invention is to provide an apparatus and a system that guards against accidental striking of a computer key whereby the device may be utilized for any specific computer keyboard key, but in a preferred embodiment would be utilized for the Caps Lock key.

Yet another exemplary embodiment of the present invention is to provide an apparatus and a system that guards against accidental striking of a computer key whereby the device may have a variable “T” configuration with a vertical member and a horizontal member.

Still another exemplary embodiment of the present invention is to provide an apparatus and a system that guards against accidental striking of a computer key whereby the device may have an adhesive bond to affix the device to the desired key on the keyboard.

Still another exemplary embodiment of the present invention is to provide an apparatus and a system that guards against accidental striking of a computer key whereby the device may have an adhesive on the device to adhere to a particular key whereby the device may also have a partial concave shape to extend at least a portion of the device above the horizontal line of adjoining keys.

Another exemplary embodiment of the present invention is to provide an apparatus and a system that guards against accidental striking of a computer key whereby the device may have a vertical member and a horizontal member whereby the vertical member is adapted to fit into the position between keys on a keyboard and further wherein the horizontal member is adapted to fit above the key that the user desires to be avoided.

An exemplary embodiment of the present invention is to provide an apparatus and a system that guards against accidental striking of a computer key whereby the device may be constructed in variable sizes to allow for fitment to any sized computer keyboard.

Still another exemplary embodiment of the present invention is to provide an apparatus and a system that guards against accidental striking of a computer key whereby the device may be constructed by injection mold, extrusion, formation, bent and any other form of construction that may produce the desired rigid key guard device.

Yet another exemplary embodiment of the present invention is to provide an apparatus and a system that guards against accidental striking of a computer key whereby the device may guard a single keyboard key and/or may guard against accidental striking of a plurality of keyboard keys.

Still another exemplary embodiment of the present invention is to provide an apparatus and a system that guards against accidental striking of a computer key whereby the device may be incorporated into OEM keyboard construction.

Another exemplary embodiment of the present invention is to provide an apparatus and a system that guards against accidental striking of a computer key whereby the device may be incorporated for retrofitting existing computer keyboards.

Yet another exemplary embodiment of the present invention is to provide an apparatus and a system that guards against accidental striking of a computer key whereby the device may be easily applied to an existing computer keyboard.

Still another exemplary embodiment of the present invention is to provide an apparatus and a system that guards against accidental striking of a computer key whereby the device may be removably attached to the key of a computer keyboard.

Another exemplary embodiment of the present invention is to provide an apparatus and a system that guards against accidental striking of a computer key whereby the device may be a one piece apparatus.

Yet another exemplary embodiment of the present invention is to provide an apparatus and a system that guards against accidental striking of a computer key whereby the device may have a horizontal portion whereby the horizontal portion overlaps the key on a keyboard thereby making it difficult to accidentally strike the overlapped key.

Still another exemplary embodiment of the present invention is to provide an apparatus and a system that guards against accidental striking of a computer key whereby the device may be easily applied to an existing keyboard by a user.

Still another exemplary embodiment of the present invention is to provide an apparatus and a system that guards against accidental striking of a computer key whereby the device has a thickness in the vertical portion whereby the thickness is adapted to fit in-between two keys on a keyboard yet not obstruct the use of any key on the keyboard.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 is a front perspective view of the apparatus in an exemplary embodiment of the present invention;

FIG. 2 is a top view of the apparatus in an exemplary embodiment of the present invention;

FIG. 3 is a bottom perspective view of the apparatus in an exemplary embodiment of the present invention; and

FIG. 4 is a top view of the apparatus in use in an exemplary embodiment of the present invention;

FIG. 5A is another view of the apparatus in use in an exemplary embodiment of the present invention;

FIG. 5B is a side view of the apparatus in an exemplary embodiment of the present invention

FIG. 5C is a perspective view of the apparatus in an exemplary embodiment of the present invention; and

FIG. 6 is another perspective view of the apparatus in an exemplary embodiment of the present invention.

### DETAILED DESCRIPTION

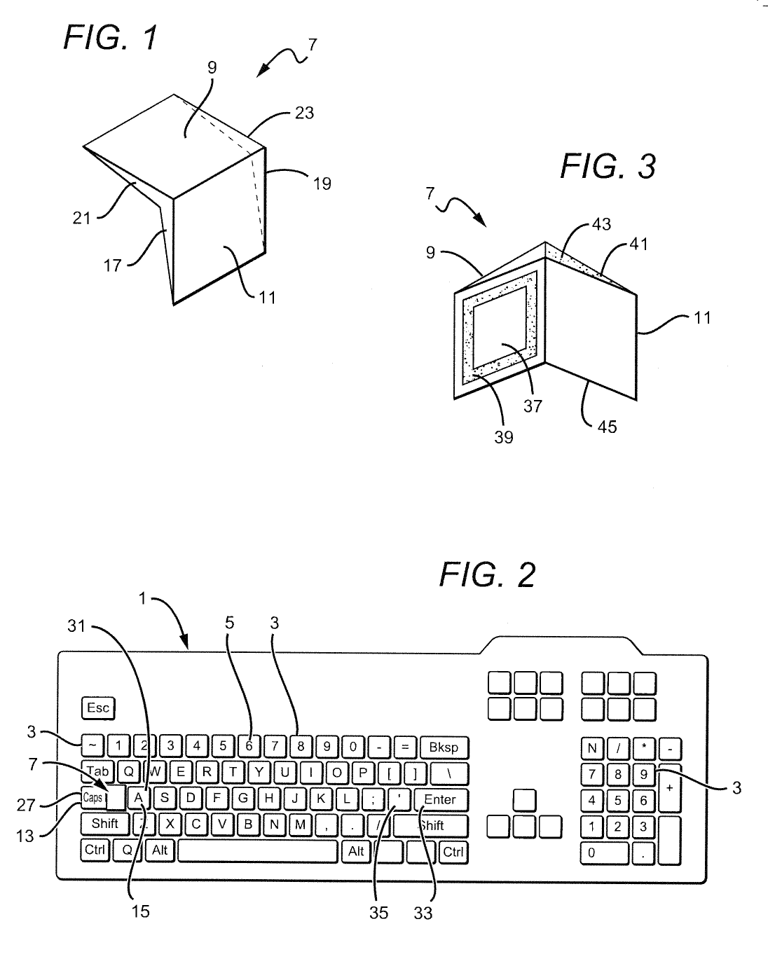

Turning now to the drawings wherein elements are identified by numbers and like elements are identified by like numbers throughout the 6 figures, the invention is depicted in FIG. 1 and illustrates an apparatus and a system 1 for preventing inadvertent striking of a computer key on a keyboard.

Referring first to FIG. 1, a typical prior art computer keyboard 1 is illustrated. The keyboard 1 has the typical QWERTY configuration having a plurality of keys 3 whereby each key 3 has indicia 5 printed thereon. As illustrated in FIG. 1, the keyboard 1 may have a plurality of square shaped keys 3 and a plurality of rectangular shaped keys 3. However, it should be understood that the shape of the keys 3 on the keyboard 1 is not relevant to the use of the device 7 described herein. In an exemplary embodiment, the key shape is rectangular, square or even triangular. However, the key lock device 7 may be utilized with any of these key configurations.

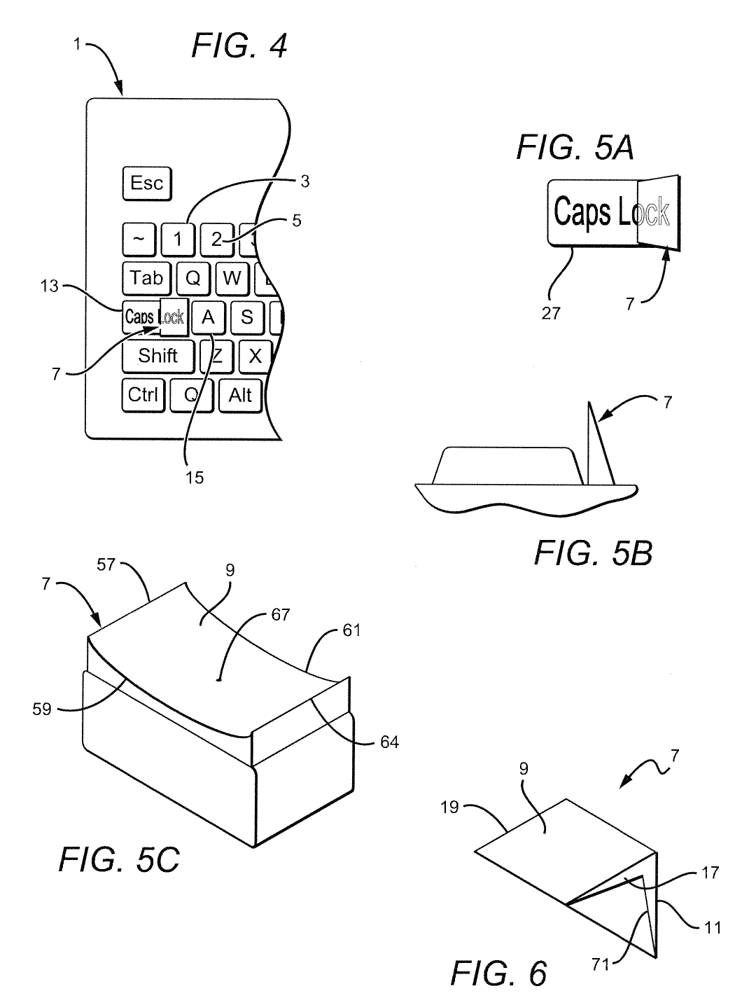

As illustrated in FIG. 1, the device 7 may have a top portion 9 typically designed to be configured in a horizontal fashion vis-a-vis the computer keyboard 1. The top portion 9 is preferably attached to a bottom portion 11 whereby the bottom portion 11 is connected to the top portion 9 and whereby the bottom portion 11 may be configured to be vertical with respect to the computer keyboard 1. Additionally, the bottom portion 11 may be adapted to fit in-between a first 13 and second key 15 as illustrated in FIG. 4. FIG. 1 also illustrates a first side portion 17 and a second side portion 19. The first side portion 17 may be configured to extend away from the top portion 9 of the device 7. The second side portion 19 may be configured to extend away from the bottom portion 11. A third side portion 21 and a fourth side portion 23 may also be utilized on the other side of the device 7 as illustrated by the broken lines on FIG. 1. The third side portion 21 and the fourth side portion 23 may also extend away from the top 9 and bottom portion 11 respectively. In an exemplary embodiment, the device 7 may be constructed to resemble an “L” shaped covering. In another exemplary embodiment, the device 7 may be constructed to resemble a “T” shaped configuration. In still another exemplary embodiment, the device 7 may be a simple vertical plane. However, it should be understood that any manner of construction could be contemplated by those skilled in the art whereby the device would have the same effect of deterring inadvertent striking of a key 3 on a keyboard 1 by a user.

FIG. 2 illustrates a typical prior art keyboard 1 accessory having the QWERTY configuration. As illustrated in FIG. 2, the keyboard 1 may have a plurality of keys 3 associated therewith for both numbers and letters. Additional keys 3 may be provided for other types of functions including music and internet accessibility. As illustrated in the Figure, the keyboard 1 may have a plurality of differently sized and shaped keys 3. For example, a square type key 3 is illustrated and further more rectangular keys are also illustrated whereby the keys 3 may border each other in very close fashion. In an exemplary embodiment, a small amount of space 25 may be provided on the keyboard 1 whereby the device 7 may fit between the space 25 provided in-between the keys 3 of the keyboard 1. FIG. 2 illustrates the fitment of the device 7 in the spaces 25 between the keyboard 1. In an exemplary embodiment, the device 7 is specifically provided for use between the Caps Lock key 27 and the letter key corresponding to the letter ‘a’ 31 on a typically keyboard 1. However, it should be understood that the device 7 may be utilized to fit between any key 3 that a user wishes to avoid inadvertent striking thereof. For example, if the user wishes to avoid striking the “RETURN” 33 key, the user may utilize the device 7 to place between the return/enter key 33 and the apostrophe symbol key 35 of a typical keyboard 1.

FIG. 3 illustrates the bottom side 37 of the top portion 9 of the device 7. As illustrated by the Figure, the bottom side 37 of the top portion 9 of the device 7 may utilize an adhesive portion 39 thereon for attachment and/or fixation to the key 3 to be avoided. The adhesive 39 may be of any fashion that would allow for removable fixation and/or attachment to the key 3. In use, the adhesive 39 would allow the bottom side 37 of the top portion 9 to be connected to the key 3 to avoid slippage of the device 7 from the specified key 3. Additionally, because the bottom portion 11 is configured to slot in between two keys 3 on the keyboard 1, and is so dimensioned such that if the device 7 is inadvertently struck by the user, the bottom portion 11 of the device 7 will not allow for depressing of the key 3 relative to the depressing of the device 7 because the bottom portion 11 of the device 7 will already be at a position where it would not be able to move in a vertical fashion, thereby not allowing movement of the key 3 in a vertical fashion.

FIG. 3 also illustrates an adhesive portion 39 positioned on at least one side 41 of the bottom portion 11. The bottom portion 11 may have a first side 43 and a second side 45 whereby either the first side 43 or the second side 45 may have adhesive portions 47 thereon whereby the adhesive portion 47 of the first 43 and/or second side 45 may allow for attachment to a desired key 3 on a keyboard 1. The adhesive portion 39 adapted for fitment on the first 43 and/or second side 45 of the bottom portion 11 may allow for removability and relocation of the device 7 to another key 3 when desired by the user. The adhesive portion 39 of the bottom portion 11 of the device 7 may be permanently affixed to an OEM version of the device 7 whereby the device is permanently affixed to a specific key in an OEM version of a keyboard 1. Whereby when a user desires to depress a specific key 3 that has the device 7 attached thereto, the user would need to take deliberate steps in order to depress that key 3. For example, the length of the key device 7 may extend only a portion over the key 3 to which it is assigned. In an exemplary embodiment, if the device 7 is utilized in order to contain and avoid inadvertent striking of the Caps Lock key 27, the device 7 may be placed in a position whereby it covers a substantial portion of the Caps Lock key 27 and further wherein the device 7 is biased toward the side of the key 3 which would most likely sustain the accidental striking of the key 3. For example, the device 7 may be placed between the ‘a’ key 31 and the “Caps Lock” key 27 as it would be most likely that a user would accidentally strike the “Caps Lock” key 27 when they really desired to strike the ‘a’ key 31.

FIG. 4 further illustrates that the device 7 may not cover the entire key 3 which it was designed to reduce the likelihood of accidental depression of said key 3. As illustrated, the device 7 may extend to cover a portion of the key 3 most adept to accidental depression. Additionally, as illustrated by FIG. 4, the device 7 may be removably attached to the key 3 and may be removed from that key 3 and placed upon another key which the user wishes to avoid striking.

FIG. 5A illustrates another embodiment of the present invention whereby the device 7 may only be comprised of a singular sloping vertical element whereby the device 7 starts in a vertical fashion and slopes to one side. Additionally, the height of the device would be higher than the typical key 3 thereby creating a barrier between a first key 13 and a second key 15 on a keyboard 1. The device 7 may fit comfortably in-between the keys 3 and slope to one side of the Y axis. FIG. 5 illustrates a side version of the singular sloping member.

FIG. 5C illustrates another exemplary embodiment of the device 7 whereby the device 7 may be a singular unit without the need for both a vertical and horizontal member. In this embodiment, the device 7 may have a top portion 9 whereby the top portion 9 has a first edge 57, second edge 59, third edge 61 and fourth edge 64 whereby the first 57 and fourth edges 64 extend and slope upwardly from the central axis 67 of the device 7. The top portion 9 of the device 7 may extend away from the bottom portion 11 of the device 7. The bottom portion 11 may sit directly on the key 3 and may have an adhesive 29 contained thereon. The device 7 may be attachably connected to the key 3. The top portion 9 would have a concave surface 69 extending from its highest points at the first 57 and fourth edges 64 of the device 7 to its lowest location on the device 7 which is preferably the central axis 67 thereof.

FIG. 6 illustrates another perspective view of the device 7 whereby the device 7 has a top portion 9 and a bottom portion 11 whereby the top portion 9 is configured to sit horizontally to the keyboard 1 and whereby the bottom portion 11 is configured to fit in-between the keys 3 of the keyboard 1. As earlier illustrated, the device 7 may have a first 17 and second side portion 19 extending away from the top portion 9 and may further have a first 17 and second side portion 19 extending away from the bottom portion 11 to more securely fit the device 7 about the key 3 such that the device 7 does not slip and/or skid from the location where the user desires it. It is contemplated that the device 7 have a second bottom portion 71 whereby the second portion 71 may be parallel to the first bottom portion 11 and whereby it would extend vertically way from a first outside edge of the top portion 9 whereby the first bottom portion 11 extends away vertically from a second outside edge of the top portion 9. This second bottom portion 71 may allow the device to substantially surround the key 3 on a keyboard 1 which may in turn remove the need for adhesives on the device 7.

Thus, specific embodiments and applications of a safety device system have been disclosed. It should be apparent however, to those skilled in the art, that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An apparatus for precluding inadvertent striking of a keyboard key, the apparatus comprising:
a removably attachable keyboard, the key guard having at least a vertical member and a horizontal member; and
the key guard affixed to at least one key and further wherein the at least a vertical member and the horizontal member preclude inadvertent striking of a specific key on a keyboard.

2. The apparatus of claim 1 wherein the key guard has an adhesive thereon to attach the key guard to at least a portion of a keyboard.

3. The apparatus of claim 1 wherein the key guard has an adhesive on the vertical member and the horizontal member whereby both the vertical member and the horizontal member may be fixably attached to the keyboard.

4. The apparatus of claim 1 wherein the key guard has a vertical member whereby the vertical member is so sized to extend from a base position on a standard keyboard to a position above the top edge of any key on a keyboard.

5. The apparatus of claim 1 wherein the key guard is intended to be used to preclude inadvertent striking of the Caps Lock key.

6. The apparatus of claim 1 wherein the key guard is intended to be utilized to preclude the inadvertent striking of any individual key on a keyboard.

7. The apparatus of claim 1 wherein the key guard is intended to be utilized to preclude the inadvertent striking of any combinations of keys on a keyboard.

8. The apparatus of claim 1 wherein the key guard is removable from a single key on a keyboard and may be further utilized to preclude striking of another key on a keyboard.

9. The apparatus of claim 1 wherein the key guard is permanently built into an original equipment by a manufacturer.

10. The apparatus of claim 1 wherein the key guard may be retrofitted to any existing keyboard by a user.

11. The apparatus of claim 1 wherein the apparatus is constructed of foam whereby the apparatus may be compressed when necessary such as in use with a laptop computer.

12. The apparatus of claim 1 wherein the apparatus is constructed of plastic.

13. The apparatus of claim 1 wherein the apparatus is constructed of any suitable rigid material that precludes a user from the inadvertent striking of a keyboard key.

14. A method for utilizing a keyboard key guard, the method comprising the steps of:
providing an attachable key guard to a keyboard, the key guard having at least a vertical member and a horizontal member; and
providing a key guard that is affixed to at least one key.

15. The method of claim 14 further comprising the step of:
allowing for utilization of the key guard with existing keyboard applications.

16. The method of claim 14 further comprising the step of:
allowing for utilization of the key guard with original keyboard equipment.

17. The method of claim 14 further comprising the step of:
providing an adhesive to allow for attachment of the key guard to any specific key on a keyboard.

18. The method of claim 14 further comprising the step of:
providing an adhesive to allow for attachment of the key guard to any combination of keys on a keyboard.

19. The method of claim 14 further comprising the step of:
placing the vertical member between any two keys on a keyboard and allowing the horizontal member to cover at least a portion of any specific key whereby when the horizontal member is struck by a user, it will not cause depression of the key because the key guard will be forced in a downward position whereby the vertical member attached to the horizontal member would hit the base portion of the keyboard and thereby preclude further downward motion of the key guard relative to the top edge of the keyboard.
